(19) United States
(12) Patent Application Publication
(10) Pub. No.: US 2007/0072563 A1
(43) Pub. Date: Mar. 29, 2007

(54) Server selection in a wireless communications network

(76) Inventor: Carl Francis Weaver, Morris Plains, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/235,347

(22) Filed: Sep. 26, 2005

(51) Int. Cl. H04B 17/00

(52) U.S. Cl. 455/115.1; 455/67.11; 455/525

(57) ABSTRACT

Disclosed is a method and system for selecting a server base station based on reverse link signal strength measurements. The method and system involve receiving, at a network controller or a server base station, signal strength measurement indications from a set of base stations for a reverse link signal transmitted by a mobile station. A base station is selected from the set of base stations to be a server based on the received signal strength measurement indications. Packet data intended for the mobile station are subsequently directed to the selected base station. The base station may be selected based solely on the reverse link signal strength measurements, or in conjunction with downlink signal strength measurements.

### FIELD OF THE INVENTION

The present invention relates generally to wireless communications network and, in particular, to selecting a radio link for packet data transmission in wireless communications network.

### BACKGROUND

Soft handoffs are one of the advantages of Code Division Multiple Access (CDMA) technology over other multiple access technologies being used for wireless communications systems because of the smooth and seamless transition provided to mobile stations traversing from one cell to another cell. Handoffs generally involve the handling of a call by a progression of base stations to keep the call active as the mobile station traverses from one cell to another cell. In soft handoff, the mobile station will establish simultaneous radio links with two or more base stations to enable the smooth and seamless transition.

Current implementations of soft handoffs involve measurements at a mobile station. Specifically, the mobile station measures received signal strengths for pilot signals transmitted from a plurality of base stations. A measurement report indicating the pilot signal strength measurements for some or all of the plurality of base stations is transmitted from the mobile station to a base station controller via some or all of the plurality of base stations. The base station controller then selects a set of base stations based on the measurement report. This set of base stations is referred to herein as an “active set”. The active set includes one or more base stations associated with the strongest pilot signal strength measurements. That is, the base stations in the active set will generally be the base stations with the more reliable radio links to the mobile station. An active set report indicating the base stations in the active set is then transmitted from the base station controller through either all the active set stations or a “server” base station to the mobile station. Typically, in a circuit voice system, all the active set base stations are used to transmit the active set report, whereas in a packet data system, only the server base station is used to transmit the active set report. Once the active set has been selected and communicated to the mobile station, simultaneous radio links can then be established between the active set base stations and the mobile station.

Although radio links are established between a mobile station and all active set base stations, not all downlink or forward link signals (i.e., signals transmitted from base stations to mobile stations) transmitted from active set base stations, such as downlink signals with weak pilot signal strength measurements, are processed by the mobile station. These non-processed downlink signals would nevertheless include information intended for the mobile station. Including such information in non-processed downlink signals is undesirable because it reduces system capacity. This loss is referred to as handoff overhead. Although this handoff overhead is a recognized disadvantage of soft handoff, it is still a worthy tradeoff since this handoff overhead allows the mobile station to almost instantaneously select the best links of the active set, thereby producing diversity gain (also known as “handoff diversity”) which more than offsets capacity cost associated with handoff overhead when dealing with continuous real time data applications, such as voice calls.

By contrast, discontinuous non-real time packet data applications can gain capacity by sending packets only when conditions are good. This is called scheduling diversity. In this case, there is no advantage from handoff diversity and, thus, it is advantageous to dispense with soft handoff on the forward link to also gain a savings of the handoff overhead.

Current state-of-the-art in packet data systems, such as those implementing the well known CDMA Evolution Data Optimized (EVDO) recognizes the difference between voice and data calls. Consequently, for data calls, such systems transmit from only one base station on the forward link although the mobile stations may maintain simultaneous radio links with multiple base stations on the uplink or reverse link (i.e., from the mobile station to the base station) when in soft handoff. Such base station is referred to herein as a “server” or “server base station”. The server would be selected based on forward link pilot signal strength measurements at the mobile station.

In a proposal for a packet data system, only the server base station would maintain a radio link with the mobile station for both uplink and downlink of a packet data call. The server would be selected based on forward link pilot signal strength measurements at the mobile station. However, this proposal can cause interference to increase on the reverse link as a result of a condition known as a “near-far” problem. The near-far problem occurs when the mobile is communicating with a server base station that is further away from the mobile than another base station. The mobile must raise its power to be received correctly at the server, but in doing so it causes a higher interference level than desired at the other base station thereby reducing system capacity.

Accordingly, there exists a need for reducing the adverse affects on system capacity due to near-far problems on the reverse link, when a single link is used for both uplink and downlink

### SUMMARY OF THE INVENTION

The present invention is a method and system for selecting a server base station based on reverse link signal strength measurements, thereby reducing the adverse effects of the near-far problems. The present invention involves receiving, at a server base station or a network controller, signal strength measurement indications from a set of base stations for a reverse link signal transmitted by a mobile station. A base station is selected from the set of base stations to be a server based on the received signal strength measurement indications. Packet data intended for the mobile station are subsequently directed to the selected base station. In one embodiment, the base station is selected based solely on the reverse link signal strength measurements. In another embodiment, the base station is selected on downlink signal strength measurements and the reverse link signal strength measurements.

### BRIEF DESCRIPTION OF THE DRAWINGS

The features, aspects, and advantages of the present invention will become better understood with regard to the following description, appended claims, and accompanying drawings where:

FIG. 1 depicts a wireless communications network used in accordance with the present invention; and

FIG. 2 depicts a flowchart in accordance with the present invention for selecting a server.

### DETAILED DESCRIPTION

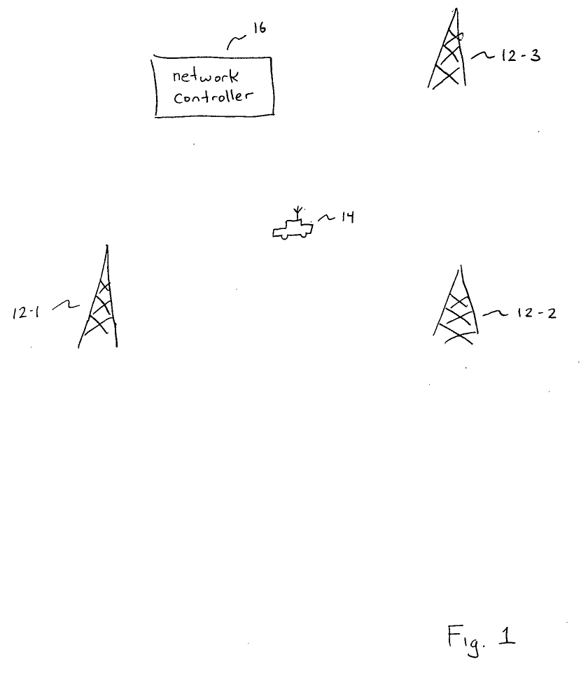

FIG. 1 depicts a wireless communications network 10 used in accordance with the present invention. Wireless communications network 10 comprises a plurality of base stations 12-n, a mobile station 14 and a network controller 16, such as a base station controller (BSC) or radio network controller (RNC). For purposes of illustration, the present invention will be described herein with respect to a wireless communications network incorporating the well-known Code Division Multiple Access (CDMA) technology. It should be understood that the present invention may be applicable to wireless communications networks incorporating other multiple access technologies.

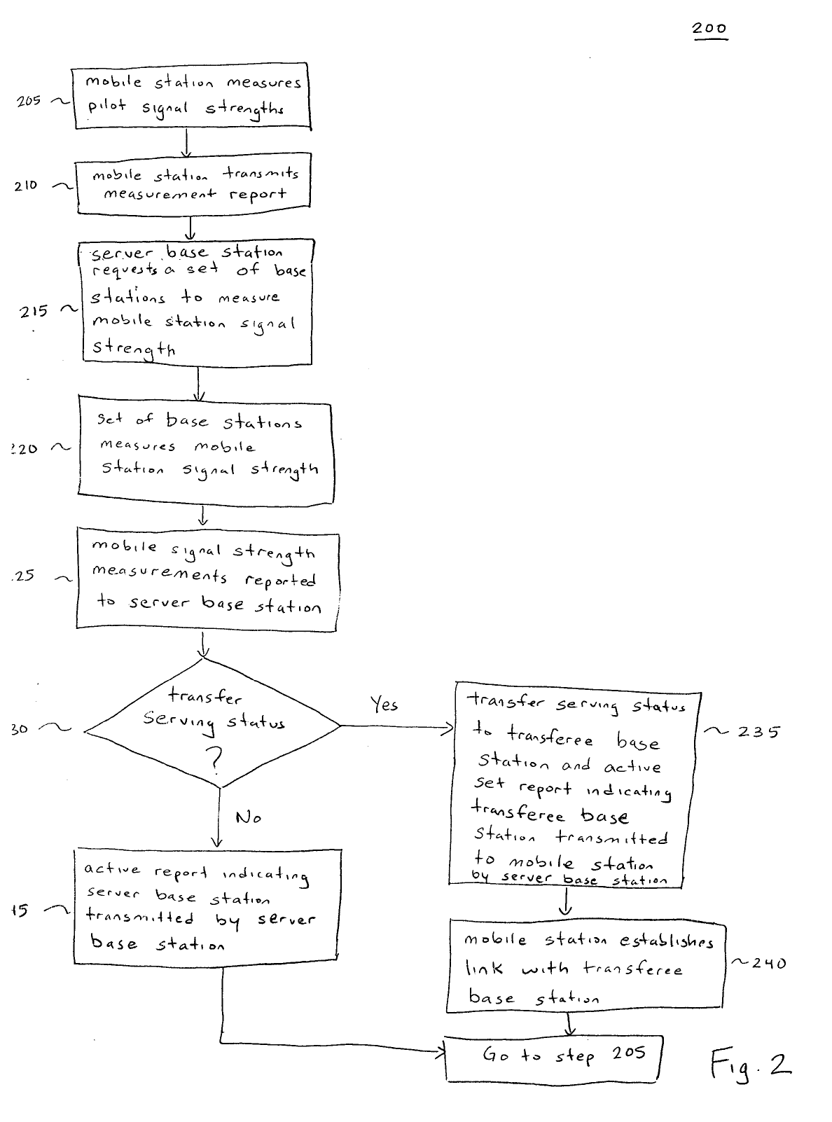

The present invention involves selecting a server for packet data calls based on signal strength measurements on the reverse link. In a preferred embodiment, the server is based on signal strength measurements for both reverse and forward links. FIG. 2 depicts a flowchart 200 in accordance with the present invention. In step 205, mobile station 14 measures received signal strengths for pilot signals transmitted from neighbor base stations 12-n. In step 210, a measurement report indicating the pilot signal strength measurements for some or all of the neighbor base stations 12-n, along with the identity of the associated base stations 12-n, is transmitted from mobile station 14 through the server base station 12-n to the network controller.

Upon receiving the measurement report, in step 215, the server base station (or, alternately, the network controller) requests a set of base stations 12-n indicated in the measurement report to measure signal strengths for reverse link signals transmitted by mobile station 14, such as a reverse link pilot signal. In one embodiment, the set of base stations 12-n would include base stations 12-n associated with the strongest or best pilot signal strength measurements on the forward link. For example, the set of base stations would include base stations 12-n associated with the four (or some other number) best pilot signal strength measurements, or any base stations 12-n associated with pilot signal strength measurements over a threshold level. In another embodiment, if the measurement report includes only the best forward link pilot signal strength measurements, all base stations 12-n indicated in the measurement report would be requested to measure signal strengths for reverse link signals transmitted by mobile station 14. In another embodiment, each base station could request a list of its neighbor base stations for reverse link pilot strength measurements on the mobile and not depend on mobile measurements at all.

In step 220, the requested set of base stations 12-n and the server base station 12-n measures the signal strengths for reverse link signals transmitted by mobile station 14. In step 225, the set of base stations 12-n reports the reverse link signal strength measurements to the server base station (or network controller). Upon receiving the reverse link signal strength measurements from set of base stations 12-n, in step 230, the server base station (or network controller) determines whether it should transfer serving status to another base station 12-n.

In one embodiment, the server base station (or network controller) determines if the server has the highest reverse link signal strength measurement compared to those associated with the other base stations 12-n. If it does have the highest reverse link signal strength measurement, the server base station (or network controller) does not transfer serving status. If it does not have the highest reverse link signal strength measurement, the server base station (or network controller) transfers serving status to the base station 12-n associated with the highest reverse link signal strength measurement.

In another embodiment, the server base station (or network controller) determines if the server has the highest combination of forward and reverse link signal strength measurements compared to those associated with the other base stations 12-n. This determination may involve summing the forward and reverse link signal strength measurements for each base station 12-n, determining which base station 12-n is associated with the highest sum, and transferring serving status to the base station 12-n associated with the highest sum if it is not the server base station 12-n. Alternately, this determination may involve using a weighted or non-weighted average of forward and reverse link signal strength measurements for each base station 12-n and determining which base station 12-n is associated with the highest average, and transferring serving status to the base station 12-n associated with the highest average if it is not the server base station 12-n. Besides weighted averages, non-linear criterion could be used to make a decision, including both forward and reverse link information.

If it is determined in step 230 that the serving status should be transferred from the current server base station 12-n to another base station (referred to herein as a “transferee base station”), then in step 235 the serving status is transferred to the transferee base station and an active set report indicating only the transferee base station 12-n is transmitted to mobile station 14 through the old server base station. In step 240, mobile station 14 receives the active set report and establishes or maintains a radio link with the transferee base station, which is now the new server base station. Because the active set only includes the transferee base station, mobile station 14 would only have a radio link with the transferee base station. From step 240, flowchart 200 returns to step 205.

If it is determined in step 230 that the serving status should not be transferred from the current server base station 12-n, then in step 245 an active set report indicating only the server base station 12-n is transmitted to mobile station 14. From step 245, flowchart returns to step 205.

The embodiment described above with respect to flowchart 200 assumes a duplex link between server base station 12-n and mobile station 14. That is, mobile station will be communicating in both forward link and reverse link directions with server base station 12-n. In an alternate embodiment, a simplex link is maintained between mobile station 14 and two base stations 12-n if a same base station 12-n is not associated with the strongest or best forward and reverse link received signal strength measurements. That is, one base station is associated with the strongest forward link received signal strength measurement, and a different base station is associated with the strongest reverse link received signal strength measurement. In this alternate embodiment, mobile station maintains a radio link in only the uplink direction with the base station 12-n associated with the strongest forward link received signal strength measurement, and a radio link in only the downlink direction with another base station 12-n associated with the strongest reverse link received signal strength measurement.

Although the present invention has been described in considerable detail with reference to certain embodiments, other versions are possible. Therefore, the spirit and scope of the present invention should not be limited to the description of the embodiments contained herein.

1. A method of operating a wireless communications network comprising the steps of:
receiving signal strength measurement indications from a set of base stations for a reverse link signal transmitted by a mobile station;
selecting a base station from the set of base stations to be a server based on the received signal strength measurement indications; and
directing packet data intended for the mobile station to the selected base station.

2. The method of claim 1 comprising the additional step of:
transmitting an active set report to the mobile station consisting of the selected base station.

3. The method of claim 2, wherein the signal strength measurement indications are received by a network controller or a server base station.

4. The method of claim 2, wherein the selected base station is a base station in the set of base stations associated with a strongest signal strength measurement.

5. The method of claim 1 comprising the additional steps of:
prior to the step of receiving the signal strength measurement indications, receiving from the mobile station a measurement report indicating pilot signal strength measurements for a plurality of base stations;
selecting the set of base stations from the plurality of base stations based on the measurement report; and
requesting the set of base stations to measure received signal strengths for a signal transmitted by the mobile station.

6. The method of claim 5, wherein the set of base stations includes base stations in the plurality of base stations associated with strongest signal strength measurements.

7. The method of claim 6, wherein the selected base station is selected based on both the measurement report and the signal strength measurement indications.

8. The method of claim 7, wherein the selected base station is selected based on a combination of pilot signal strength measurements and reverse link signal strength measurements.

9. The method of claim 8, wherein the selected base station is selected based on an average of pilot signal strength measurements and reverse link signal strength measurements.

10. The method of claim 8, wherein the selected base station is selected based on a weighted average of pilot signal strength measurements and reverse link signal strength measurements.

11. A wireless communications network comprising:
a plurality of base stations; and
a network controller for receiving signal strength measurement indications from the plurality of base stations for a reverse link signal transmitted by a mobile station, for selecting a base station from the set of base stations to be a server based on the received signal strength measurement indications, and for directing packet data intended for the mobile station to the selected base station.

12. The wireless communications network of claim 1, wherein at least one base station in the plurality of base station is operable to transmit an active set report to the mobile station consisting of the selected base station.

13. The wireless communications network of claim 2, wherein the selected base station is a base station in the set of base stations associated with a strongest signal strength measurement.

14. The wireless communications network of claim 1, wherein at least one base station in the plurality of base stations is operable to receive from the mobile station a measurement report indicating pilot signal strength measurements for the plurality of base stations, and the network controller being further operable to select the set of base stations from the plurality of base stations based on the measurement report and to request the set of base stations to measure received signal strengths for a signal transmitted by the mobile station.

15. The wireless communications network of claim 14, wherein the set of base stations includes base stations in the plurality of base stations associated with strongest signal strength measurements.

16. The wireless communications network of claim 15, wherein the selected base station is selected based on both the measurement report and the signal strength measurement indications.

17. The wireless communications network of claim 16, wherein the selected base station is selected based on a combination of pilot signal strength measurements and reverse link signal strength measurements.

18. The wireless communications network of claim 17, wherein the selected base station is selected based on an average of pilot signal strength measurements and reverse link signal strength measurements.

19. The wireless communications network of claim 17, wherein the selected base station is selected based on a weighted average of pilot signal strength measurements and reverse link signal strength measurements.
